(19) United States
(12) Patent Application Publication
(10) Pub. No.: US 2016/0163130 A1
(43) Pub. Date: Jun. 9, 2016

(54) Method and Apparatus for Connected Vehicle System Wear Estimation and Maintenance Scheduling

(71) Applicant: Ford Global Technologies, LLC, Dearborn, MI (US)

(72) Inventors: Jovan Milivoje Zagajac, Ann Arbor, MI (US); Arun Chopra, Northville, MI (US); Vasiliy V. Krivtsov, Ann Arbor, MI (US); Oleg Yurievitch Gusikhin, West Bloomfield, MI (US)

(21) Appl. No.: 14/563,101

(22) Filed: Dec. 8, 2014

(51) Int. Cl. G07C 5/08

(52) U.S. Cl. CPC G07C 5/0808

(57) ABSTRACT

A system includes a processor configured to receive vehicle identifying data. The processor is also configured to receive system wear-related data from a vehicle system-utilization event. The processor is further configured to aggregate system wear-related data. Also, the processor is configured to compare system wear-related data to data gathered from vehicles for which actual wear measurements were taken to determine a projected system wear-state. Additionally, the processor is configured to determine if the projected wear-state exceeds a replacement threshold and recommend system servicing based on the projected wear-state being past the replacement threshold.

### TECHNICAL FIELD

The illustrative embodiments generally relate to a method and apparatus for connected vehicle system wear estimation and maintenance scheduling.

### BACKGROUND

The internet of things, including, for example, a connected vehicle, creates game changing opportunities for vehicle service and maintenance. The ability to deliver communication from the vehicle to the original equipment manufacturer, and to the dealer, and to deliver responsive communication back to the driver, provides for a level of customer service unmatched in previous history. Vehicle connectivity allows for better anticipation of customer needs and on-demand customer and vehicle communication, leading to opportunities for improving customer satisfaction and brand loyalty.

Various strategies have been developed for providing an estimate of brake pad thickness. One method employs fusion of sensors, if used, and driver brake modeling to predict the vehicle brake pad life. An algorithm is employed that uses various inputs, such as brake pad friction material properties, brake pad cooling rate, brake temperature, vehicle mass, road grade, weight distribution, brake pressure, brake energy, braking power, etc. to provide the estimation. The method calculates brake work using total work minus losses, such as aerodynamic drag resistance, engine braking and/or braking power as braking torque times velocity divided by rolling resistance to determine the brake rotor and lining temperature. The method then uses the brake temperature to determine the brake pad wear, where the wear is accumulated for each braking event. A brake pad sensor can be included to provide one or more indications of brake pad thickness from which the estimation can be revised.

In another strategy, a system and method for enhancing vehicle diagnostic and prognostic algorithms and improving vehicle maintenance practices include collecting data from vehicle components, sub-systems and systems, and storing the collected data in a database. The collected and stored data can be from multiple sources for similar vehicles or similar components and can include various types of trouble codes and labor codes as well as other information, such as operational data and physics of failure data, which are fused together. The method generates classes for different vehicle components, sub-systems and systems, and builds feature extractors for each class using data mining techniques of the data stored in the database. The method also generates classifiers that classify the features for each class. The feature extractors and feature classifiers are used to determine when a fault condition has occurred for a vehicle component, sub-system or system.

### SUMMARY

In a first illustrative embodiment, a system includes a processor configured to receive vehicle identifying data. The processor is also configured to receive system wear-related data from a vehicle system-utilization event. The processor is further configured to aggregate system wear-related data. Also, the processor is configured to compare system wear-related data to data gathered from vehicles for which actual wear measurements were taken to determine a projected system wear-state. Additionally, the processor is configured to determine if the projected wear-state exceeds a replacement threshold and recommend system servicing based on the projected wear-state being past the replacement threshold.

In a second illustrative embodiment, a system includes a processor configured to receive vehicle identifying data. The processor is also configured to receive brake wear-related data from a vehicle system-utilization event. Further, the processor is configured to aggregate brake wear-related data. The processor is additionally configured to compare brake wear-related data to data gathered from vehicles for which actual wear measurements were taken to determine a projected brake wear-state. Further, the processor is configured to determine if the projected wear-state exceeds a replacement threshold and recommend system servicing based on the projected wear-state being past the replacement threshold.

In a third illustrative embodiment, a non-transitory computer readable storage medium, stores instructions that, when executed, cause a processor to perform a method including receiving vehicle identifying data. The method also includes receiving system wear-related data from a vehicle system-utilization event. Further, the method includes aggregating system wear-related data and comparing system wear-related data to data gathered from vehicles for which actual wear measurements were taken to determine a projected system wear-state. Also, the method includes determining if the projected wear-state exceeds a replacement threshold and recommending system servicing based on the projected wear-state being past the replacement threshold.

### BRIEF DESCRIPTION OF THE DRAWINGS

FIG. 1 shows an illustrative vehicle computing system;

FIG. 2A shows an illustrative vehicle system wear-related data reporting and service scheduling system;

FIG. 2B shows some illustrative examples of actual data to be gathered for a specific system;

FIG. 3 shows an illustrative process for reporting brake wear data and scheduling service;

FIG. 4 shows an illustrative process for brake wear evaluation; and

FIG. 5 shows an update process for brake wear estimation modeling.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

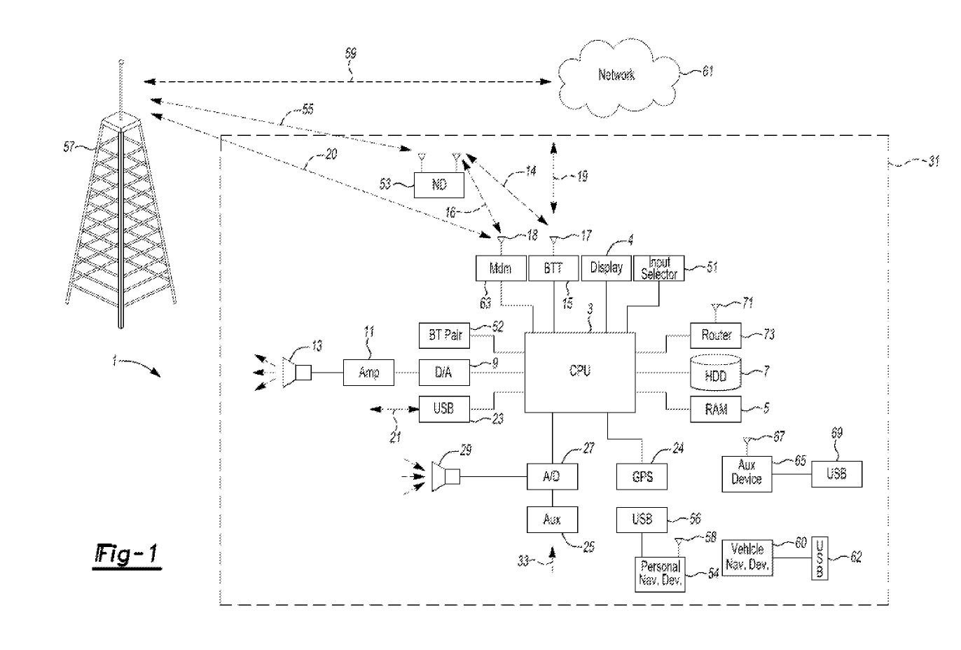

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touch screen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a Wi-Fi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., Wi-Fi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

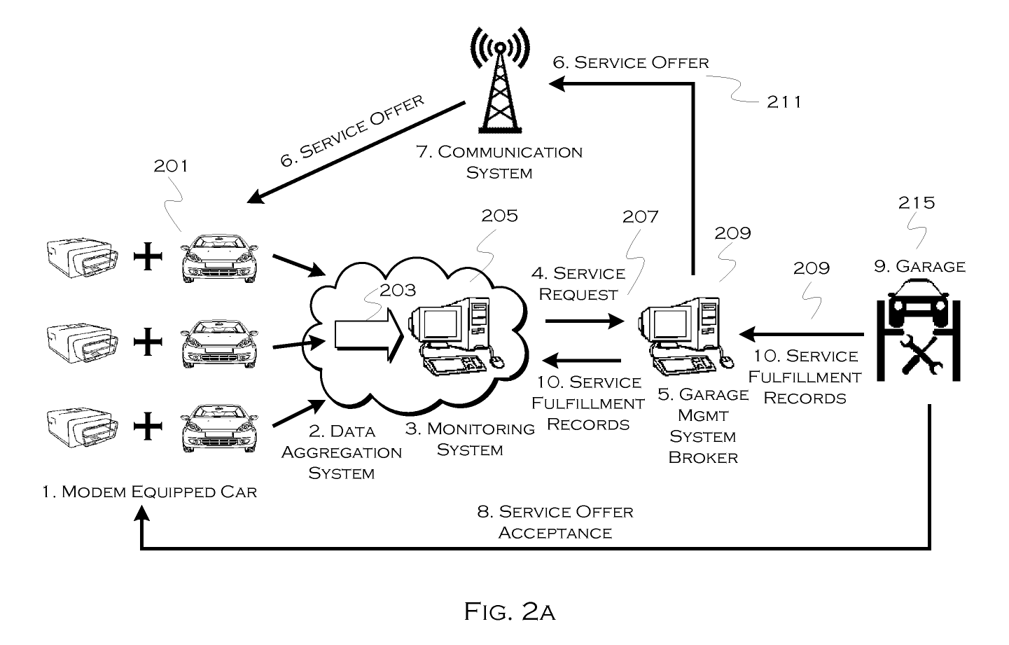

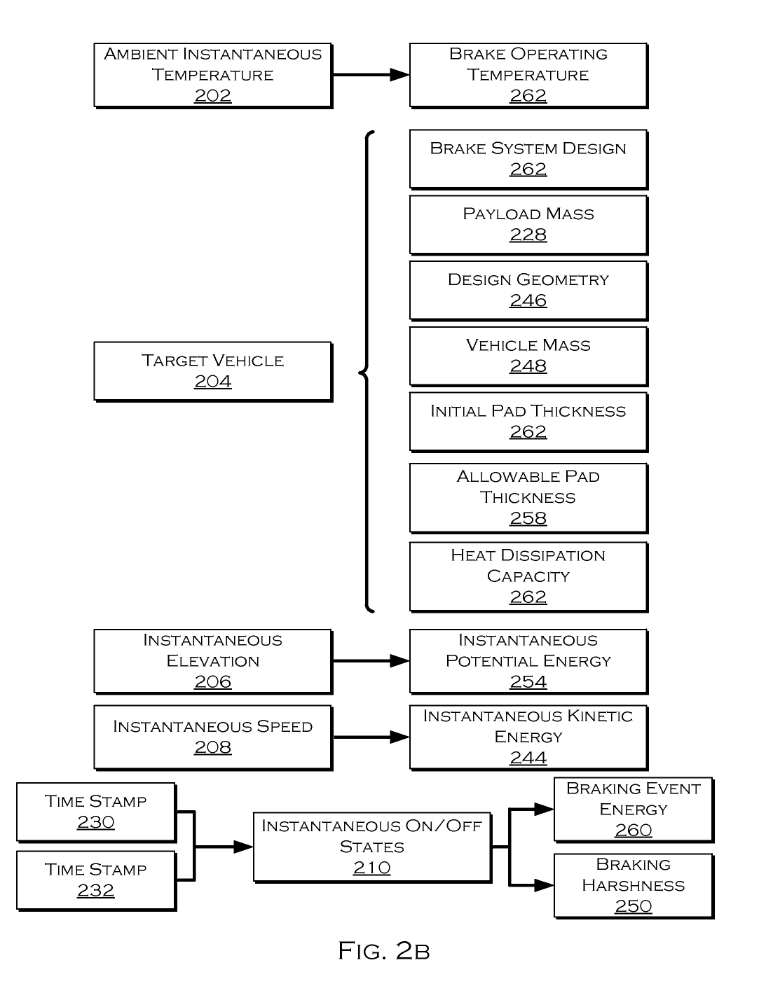

FIG. 2A shows an illustrative vehicle system wear-related data reporting and service scheduling system. In the illustrative example shown in FIG. 2, a modem equipped vehicle 201 may utilize a telematics control unit or OBD2 connected modem, for example, to continuously monitor vehicle factors that may affect vehicle system wear. In the illustrative examples, specific examples are given with respect to brake wear, but it is to be understood that the techniques and processes illustrated herein could be applied to numerous mechanical and electrical system. Essentially, any system showing a marked correlation between vehicle-measurable data and actual part wear or degradation is a candidate for inclusion in the illustrative embodiments.

With respect to brakes, vehicle measureable data includes, but is not limited to, vehicle deceleration, vehicle speed, ambient temperature, ambient humidity, vehicle location, harsh stops, yaw, lateral acceleration, engagement of brakes, etc. This information can be retrieved from vehicle sensors and provided to a vehicle network, such as the CAN network. The telematics control unit or other modem/communication providing device can pull messages including this data off of the CAN or other vehicle network and transport the data to a remote server. In other mechanical systems, measurable mechanical data having a marked correlation to degradation of the mechanical system (various forces exerted during utilization and overall utilization, combinatorially referred to generically as a duty cycle) can be measured and used as discussed with respect to the braking system to estimate wear on the mechanical system. In a similar manner, for electrical systems where utilization and electrical measurables correlate to a degradation in the electrical system, those factors can be used as a proxy for “wear” on the system in accordance with the illustrative embodiments.

The remote server 203 may aggregate the received data by vehicle identification number (VIN) and time, so that a model for daily vehicle system usage can be obtained for individual vehicles. This aggregated data for a variety of vehicles can be used to build a continuously learning system wear model (in this example, a brake pad wear model). A correlation between energy dissipated through braking (e.g., the integral of vehicle deceleration times mass over time, or the difference between vehicle kinetic energy before and after a braking event) to brake pad replacement frequency can be made. This may vary with location and environmental conditions as well. Accuracy of results can be refined over time by examining actual pad wear when a vehicle has its brakes serviced.

By providing this calculation for a large number of vehicles, a statistical model of maintenance events as a function of vehicle duty cycle and location/environment can be obtained. A monitoring system 205, using this model, can predict when brake pad replacement will be required by extrapolating the duty cycle for each vehicle and comparing that duty cycle to the statistical maintenance threshold (e.g., point where brakes are worn to replacement condition). When the threshold cross is observed/predicted, a service recommendation can be generated for the vehicle.

For all vehicles in a given monitoring set (the “fleet”), duty cycle data may be monitored continuously at a relatively low cost. This typically involves existing sensors and calculations that can be made based on data observable using presently installed vehicle systems. For example, with the brake model, energy dissipated is measured as the integral of vehicle deceleration times mass over time, resulting in the delta between vehicle kinetic energy prior to and following a braking event. Since vehicle mass is generally known and deceleration can easily be measured, no additional sensors are needed in a vehicle to obtain this data.

The data itself is aggregated with other previously measured and observed data to develop an aggregate “duty cycle” (i.e., utilization and applicable forces observed during utilization) for the vehicle to present (or, for example, from a last system repair to present). This duty cycle can be compared to known thresholds for similar vehicles, obtained by taking actual wear values from a select sub-set of vehicles and noting the actual duty cycles associated with those wear values. These actual wear values do not need to be measured for all vehicles, it is sufficient to measure the values for some subset of similarly equipped vehicles and to extrapolate the likely wear values on similar vehicles having similar duty cycle values. If the measured data for a given vehicle indicates a likelihood (based on the vehicle's measured duty cycle compared to the duty cycle of a vehicle explicitly known to exhibit system wear at the measured value) of system wear requiring repair, a service recommendation may be generated.

Once the service recommendation has been generated, it may be sent 207 to a garage system management broker 209 for scheduling service on the particular vehicle identified with respect to the request. This system may manage one or more garages/dealerships and may be responsible for scheduling maintenance for the managed locations. After finding an available timeslot for servicing the brakes, the process may send a service offer 211 to the vehicle for delivery to the vehicle driver. This can include any number of recommended times and/or locations, and can be presented to the driver in a selectable format (e.g., through touch-response, voice-response, etc.).

Once the customer accepts an available timeslot, the process can send a response 213 to the particular garage so that the garage expects the customer at the agreed-upon time. The customer then arrives at the garage 215 and servicing is performed.

In the illustrative examples, the servicing is performed on the basis of an estimated need for brake repair based on estimated wear. Accordingly, it may be useful to examine actual wear on the brake pads to determine how accurate the wear estimate actually was. Once the brake pads have been replaced, this data 219 can be sent (through the management system broker or directly) to the monitoring system for updating the model of the brake pads so that future modeling more accurately reflects the actual state of pads upon servicing.

FIG. 2B shows an illustrative example of a large (but not exhaustive) number of wear affecting variables that may be measured with respect to an exemplary braking system. This is not intended to be limiting in any manner, but merely illustrative of the data that can be gathered with respect to a system for a comparison to approximate wear on the system and variables that may be affected by this data.

For example, in this illustrative embodiment, ambient instantaneous temperature 202 may be a factor for brake operating temperature 262. The target vehicle 204 may have associated data indicating brake system design 226, payload mass 228 (which may be estimated or measurable) design geometry 246, vehicle mass 248, initial pad thickness 256, allowable pad thickness 258, and heat dissipation capacity 262 (as can be seen from this model, some data is not measured but is merely data relating to a vehicle make/model/line/etc.).

Instantaneous elevation 206 and instantaneous speed 208 can be utilized to determine instantaneous potential energy 254 and instantaneous kinetic energy 244 respectively. Time stamps 230, 232 indicate instantaneous on/off states 210 of the brake system, which in turn can be used to determine braking event energy 260 and braking harshness 250. Similarly, ignition time stamps 234, 236 demonstrate ignition on/off states 214 which can be factors in brake operating temperatures. Other instantaneous measureables, such as acceleration 212, humidity 216, vehicle pitch 218, vehicle location 220, and date 222 affect various brake calculations. The GPS location can be used in determining terrain type 238, and duty cycle 252. Much of the data can be used to “guess” accumulated instantaneous wear 266 and instantaneous pad thickness 268, which in turn can be used to extrapolate remaining pad life 270. A certain number of days before a pad is projected to pass an acceptable thickness threshold 272, the process can generate a maintenance notification.

At the same time, for a select group of vehicles, inspection events 224 result in actual pad thickness data based on some or all of the above factors. This actual data can be stored with respect to some or all of the above factors, and this data can be compared to data for vehicles on the road for which inspection events have not occurred. For vehicles having brakes (in this example) with similar mechanical properties, and which (vehicles) exhibit similar measurables, it is assumed that brake wear in those vehicles approximates observed brake wear in the vehicle for which the inspection event occurred. Actual pad thickness 240 and a date stamp 242 are also recorded, so a later measurement will reveal deterioration based on the factors measured since the last date stamp (allowing further extrapolation with respect to vehicles for which actual measurements are not taken).

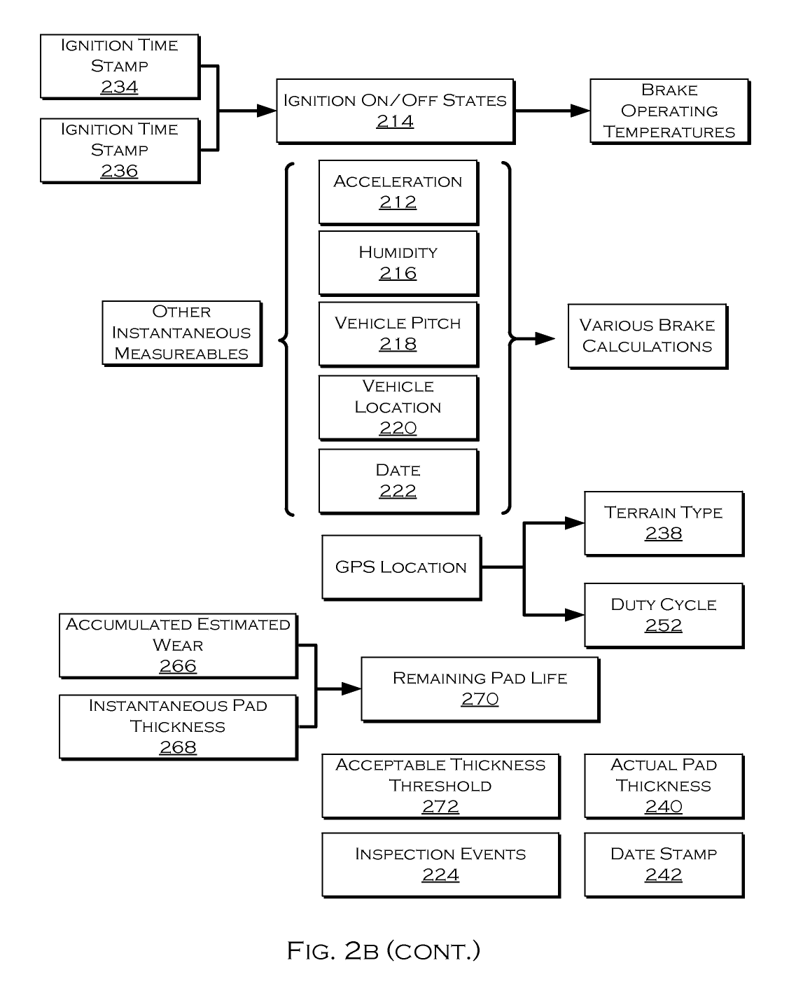

FIG. 3 shows an illustrative process for reporting brake wear data and scheduling service. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

The illustrative example shown in FIG. 3 shows a process that runs on the vehicle system, although some or all of the process (with appropriate amendments) could run on the monitoring system or on other non-vehicular systems. In this illustrative example, the process gathers the appropriate system wear-related data (in this example, brake wear-related data). Since outcome-affecting data may vary with location and with the refinement of the modeling, it may be useful to specify which data should be gathered. As the vehicle is capable of communication with the remote monitoring system, where the modeling may be performed and refined, instructions to gather new data may be provided at given times for the vehicle.

For example, without limitation, in the brake example the process may periodically instruct the vehicle to measure stopping distance with respect to braking force. Based on the recorded observed data for similar vehicles, this measured data can be used to determine diminishment in brake pads. This can be accomplished, for example, by comparison of the measured data to data measured in vehicles for which wear was actually also measured. This and similar comparisons can give at least a rough estimation of the accuracy of models for wear. Other variables and their respective usefulness may change over time, and through dynamic modification of the data gathered, the system can keep the data gathering relevant and useful.

Any gathered data, along with relevant vehicle identification and timestamps, if desired, can be exported to the monitoring system for evaluation 303. The monitoring system, following evaluation, can notify the driver if any maintenance is likely to be needed 305. If no maintenance is likely needed, the process can continue to gather the appropriate vehicle data and provide updated data to the monitoring system.

If and when maintenance is needed, the process may communicate with a dealer/garage management system to receive a service offering 307. This offering can include incentives to use certain dealerships or timeslots, or incentives to perform the servicing before the brake pads become dangerously worn. The process can present the received service options to a customer in a selectable manner (or via a secondary device, such as a phone) and receive customer selection of a service option 309.

If no service option is selected at this time, the process may continue at periodic intervals to offer service until the offerings are ignored/disabled or servicing is performed 311 elsewhere (outside the automatic scheduling options, although the service could be performed at a dealer identified through the automatic scheduling options and scheduled through a different manner). On the other hand, if the customer elects to participate in the service offering, the process can receiving scheduling options for the customer 313. These options can be drawn from available service timeslots large enough to complete a brake replacement/repair job, and can be identified from one or more local service providers by the monitoring system, for example. The driver may have a preferred service provider, and times can be provided for that provider, but times may also be provided based on service providers that are proximate to the vehicle location, that are offering specials, etc.

The options for scheduling may be presented to the customer in a selectable manner. For example, without limitation, the customer can be presented with a voice selectable set of options, a touch-selectable set of options, a scroll-and-select list, etc. The options can also be presented visually or audibly. The customer selects one of the presented options 315, in this example, and resultantly an appointment is scheduled 317. The process will monitor the wear using the current model until the appointment is completed 319. Once the appointment is completed, the actual wear on the pads, and any other needed brake repair data, may be sent to the modeling process for comparison to estimated wear and repair needs, and for use in improving the modeling process.

For example, without limitation, a model may project that a set of pads are 70% worn, and that the brake calipers need repair, based on data observed over the life of the brakes when processed through modeling developed from the same or similar vehicles and/or in similar environments. Upon actual repair, the calipers may be observed to be in working and usable condition, and the pads may only be 55% worn. This data can be used to refine the model, either generally and/or for the specific vehicle, vehicle make/model, etc. The specific vehicle model may be impacted more drastically by the observed data than a generalized model, which may require data from a number of vehicles before drastic adjustment is made, to avoid pollution of the data by outliers. By using generalized models of varied types (environmental wear, make/model wear, vehicle class wear) and/or vehicle-specific models based on observed effect of vehicle specific factors, the process can be refined over time and various affects of braking can be modeled for a specific set of brake pads.

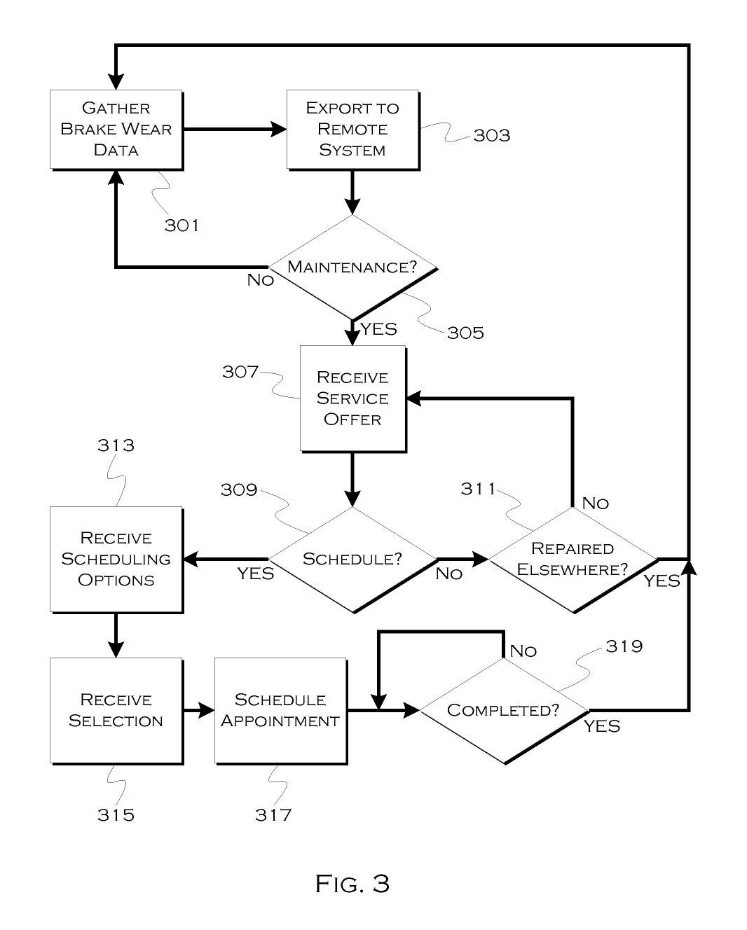

FIG. 4 shows an illustrative process for system wear evaluation (brake wear, in the example). With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, vehicle data is gathered with respect to a braking vehicle. The data is received at a processing point, where modeling will be performed. In this illustrative example, this is a monitoring system, and the vehicle data has been transferred via a wireless connection to the monitoring system. In other examples, the modeling process could be run directly on a mobile device, or in a vehicle computer, if the processing capacity were sufficient. Updates to a remotely stored model could be transferred to the locally running modeling process when appropriate.

The process receives vehicle data 401, which includes, but is not limited to, vehicle identification, any needed vehicle characteristics, environmental data, road data, etc. With respect to the equipment provided to a given vehicle, this can be stored at an initial point and updated as appropriate if the vehicle configuration is modified (e.g., without limitation, aftermarket parts, different tires, etc.). Environmental and road data may be more dynamic in nature, and can either be gathered from the vehicle directly or, for example, can be crowd-sourced for a given location or locality.

In addition to the vehicle data, the process may receive braking data 403, indicating, among other things, braking force, decrease in velocity over distance, duration of braking, etc. Any braking data useful to model wear on the brakes may be received here. The modeling process may then use the received data, in conjunction with one or more models or algorithms to calculate projected wear on the brake pads and other brake parts. In this example, the vehicle data included a vehicle identification number (VIN) or other vehicle identifying characteristic usable to identify a specific vehicle. This allows saving of the braking data for the specific vehicle and, for example, use of any models that may have been developed for the specific vehicle, if models are implemented at such a refined level.

The braking data wear calculations can be aggregated for the vehicle 407 to model a present-condition of the vehicle braking system. This data can then be compared to, for example, a duty cycle threshold 409 for the vehicle, to determine if the brakes have reached a state where repair/replacement is recommended. If the brake condition has passed the threshold for replacement/repair 411, the process may recommend brake service/maintenance 413. Otherwise, the process may exit until further data is available.

As the actual wear can be measured on a subset (as opposed to total) of vehicle population, wear modeling can be achieved through application of a variation of the Kaplan-Meier Product Limit Estimator. In Kaplan-Meier, S(t) is the probability that an item from a given population will have a lifetime wear) exceeding t. From a sample population of size N, the observed times of N sample members can be represented as

t₁≦t₂≦t₃≦ . . . ≦t_{N}

Corresponding to teach tᵢ is nᵢ, the number “at risk” just prior to time tᵢ and dᵢ, the number of deaths at time tᵢ (death=replacement−requiring wear) The Kaplan-Meier estimator is the non-parametric maximum likelihood estimate of S(t). It is a product of the form

$$\hat{S} ( t ) = {Π}_{{t}_{i} < t} \frac{{n}_{i} - {d}_{i}}{{n}_{i}}$$

This equation can be used to estimate the probability that a system from the group of vehicles will have wear exceeding t.

Also used is a modified survival regression model. Typically used in clinical settings to show the probability of a patient surviving cancer after treatment x, the base formula is

S(T|x)=exp[−∫₀^{T}h(t|x)dt]

Where S(T|x) is the survival probability (i.e., “reliability”) of a patient conditional on the vector of explanatory variables or covariates x. h(t|x) is the hazard function.

Fixed covariates are represented by

h(t|x)=h₀(t)exp{β^{T}x}

Where t is the time to failure (death), h(t|x) is the hazard function, h₀(t) is the baseline hazard function and β^{T} is the transposed vector of coefficients.

Time dependent covariates are represented by

h(t|x)=h₀(t)exp{β^{T}x(t)}

Where x(t)=_{0,if a patient didn't receive a transplant as of t}^{1,if a patient received a transplant as of t}

This formula can be modified to a wear context formula

$$R ( w , x ) = 1 - Φ [ \frac{log ( w ) - {μ}_{w} ( x )}{{σ}_{w}} ]$$

Where w is brake pad wear, φ[ ] is the standard normal CDF for normal and lognormal distributions and the smallest extreme value CDF for the Weibull distribution; μ, σ are the location and scale parameters of the wear distribution, respectively, x is the vector of explanatory values (e.g., without limitation, consumed energy, temperature, humidity, etc.).

In this modified formula, the fixed covariates are represented by

μ_{W}(x)=β₀+βᵢx

Where βᵢ model parameters are estimated from data.

Using these formulas, it is possible to model the probability of wear on a vehicle exceeding a predetermined threshold (recorded for each vehicle identification number (VIN)). These formulas can also be used to determine, for each vehicle (which includes a large number of vehicles for which actual wear data was never measured, merely extrapolated), the projected incremental mileage (based on a recorded trajectory of mileage accumulation) to a critical wear point. This prediction can be conveyed to a driver and to a manufacturer or dealer so that appropriate action can be taken long before the system passes a critical wear point. Furthermore, knowing the rate of break energy accumulation for each vehicle, it is then possible to predict number of days remaining to a critical wear point—thus enabling to schedule individualized (by VIN) service appointments in calendar time.

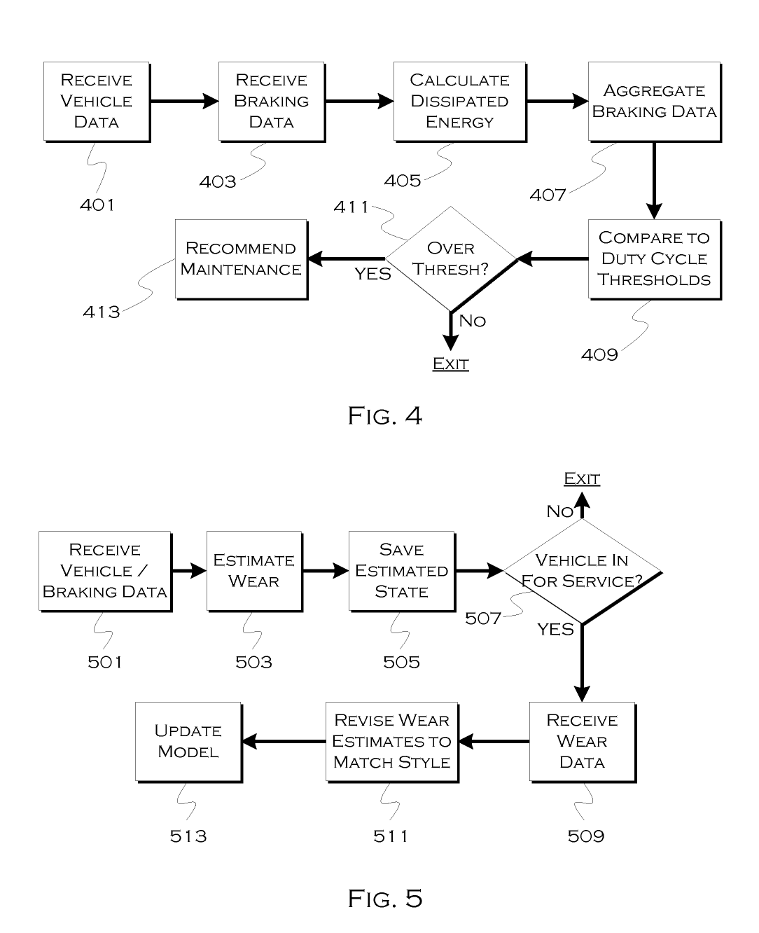

FIG. 5 shows an update process for brake wear estimation modeling. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process again gathers the vehicle and system wear-related data for any appropriate instances of system utilization (braking, in this example). This data can be aggregated locally on the vehicle and delivered at specified intervals, if desired, to avoid transmission of data and bandwidth utilization every time the brakes are applied. The process also utilizes modeling algorithms to determine estimated wear on the vehicle system 503 and saves this system-state data 505 with respect to the individual vehicle.

When the vehicle goes in for service 507, the model may be updated based on the actual, observed condition of the brakes. Participating dealers and service shops will be incentivized to report the data to improve the modeling process, so that brake replacement may be more accurately modeled and customers can be appropriately notified when brakes need replacement.

When the brakes are actually serviced, the service location can examine the brake components and report actual wear and damage data, which is received by the modeling engine 509. This can be used to revise the wear estimates 511, so that the incoming data more accurately models the actual wear observed on the brake system components. Once the appropriate modifications have been made to the estimates, any changes to the model itself can be made as appropriate.

For example, without limitation, when sufficient data for a given climate is received, it can be observed that winter braking in conditions below 10 degrees Fahrenheit results in a greater increase in brake wear than anticipated. Accordingly, estimates based on braking in such conditions may be appropriately modified. Additionally or alternatively, the model itself may be revised to incorporate the observed change for data received that includes a temperature condition below 10 degrees Fahrenheit.

Through the use of the modeling process, brake replacement needs can be accurately predicted and conveyed to a customer. At the same time, participating dealerships and service locations can report actual data to improve the modeling process. These locations can also provide available service timeslots for use by customers whose brakes are projected to be in need of repair.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive vehicle identifying data;
receive system wear-related data from a vehicle system-utilization event;
aggregate system wear-related data;
compare system wear-related data to data gathered from vehicles for which actual wear measurements were taken to determine a projected system wear-state;
determine if the projected wear-state exceeds a replacement threshold; and
recommend system servicing based on the projected wear-state being past the replacement threshold.

2. The system of claim 1, wherein the processor is further configured to determine an estimated time until replacement based on observed usage representing projected usage, compared to known wear for vehicles exhibiting usage similar to the projected usage for which actual wear data was measured.

3. The system of claim 2, wherein the processor is configured to report the estimated time until replacement to a driver.

4. The system of claim 1, wherein the processor is configured to store aggregated estimated wear with respect to a vehicle record, identifiable based on the received vehicle identifying data.

5. The system of claim 1, wherein the processor is configured to request transmission of one or more available service timeslots in response to recommending system servicing.

6. The system of claim 5, wherein the processor is configured to receive actual system wear data from a service location associated with the selected service timeslot following a system repair, and wherein the processor is configured to update a system wear-model based on the received system wear data and the aggregated system wear-related data.

7. The system of claim 1, wherein the processor is configured to generate a generalized system wear model based on duty cycle, expressing system degradation as a function of vehicle utilization and usable for the comparison as indicative of data gathered from vehicles for which actual wear measurements were taken.

8. A system comprising:
a processor configured to:
receive vehicle identifying data;
receive brake wear-related data from a vehicle system-utilization event;
aggregate brake wear-related data;
compare brake wear-related data to data gathered from vehicles for which actual wear measurements were taken to determine a projected brake wear-state;
determine if the projected wear-state exceeds a replacement threshold; and
recommend system servicing based on the projected wear-state being past the replacement threshold.

9. The system of claim 8, wherein the processor is further configured to determine an estimated time until replacement based on observed usage representing projected usage, compared to known wear for vehicles exhibiting usage similar to the projected usage for which actual wear data was measured.

10. The system of claim 9, wherein the processor is configured to report the estimated time until replacement to a driver.

11. The system of claim 8, wherein the processor is configured to store aggregated estimated wear with respect to a vehicle record, identifiable based on the received vehicle identifying data.

12. The system of claim 8, wherein the processor is configured to request transmission of one or more available service timeslots in response to recommending brake servicing.

13. The system of claim 12, wherein the processor is configured to receive a customer selection of a service timeslot.

14. The system of claim 13, wherein the processor is configured to receive actual brake wear data from a service location associated with the selected service timeslot following a brake repair, and wherein the processor is configured to update a brake wear-model based on the received brake wear data and the aggregated brake wear-related data.

15. A non-transitory computer readable storage medium, storing instructions that, when executed, cause a processor to perform a method comprising:
receiving vehicle identifying data;
receiving system wear-related data from a vehicle system-utilization event;
aggregating system wear-related data;
comparing system wear-related data to data gathered from vehicles for which actual wear measurements were taken to determine a projected system wear-state;
determining if the projected wear-state exceeds a replacement threshold; and
recommending system servicing based on the projected wear-state being past the replacement threshold.

16. The storage medium of claim 15, wherein the method further includes determining an estimated time until replacement based on observed usage representing projected usage, compared to known wear for vehicles exhibiting usage similar to the projected usage for which actual wear data was measured.

17. The storage medium of claim 16, wherein the method includes reporting the estimated time until replacement to a driver.

18. The storage medium of claim 15, wherein the method includes storing aggregated estimated wear with respect to a vehicle record, identifiable based on the received vehicle identifying data.

19. The storage medium of claim 15, wherein the method includes requesting transmission of one or more available service timeslots in response to recommending system servicing.

20. The storage medium of claim 19, the method further including receiving a customer selection of a service timeslot.
